(19) United States
(12) Patent Application Publication
(10) Pub. No.: US 2016/0080241 A1
(43) Pub. Date: Mar. 17, 2016

(54) Gigabit Determination of Available Bandwidth Between Peers

(71) Applicant: Broadcom Corporation, Irvine, CA (US)

(72) Inventors: Marcelo Augusto Rocha De Maria, Irvine, CA (US); Joel David Peshkin, San Juan Capistrano, CA (US)

(21) Appl. No.: 14/753,694

(22) Filed: Jun. 29, 2015

Related U.S. Application Data
(60) Provisional application No. 62/182,675, filed on Jun. 22, 2015.
(60) Provisional application No. 62/051,356, filed on Sep. 17, 2014.

(51) Int. Cl. H04L 12/26; H04L 29/06

(52) U.S. Cl. CPC H04L 43/50; H04L 43/0864; H04L 43/16; H04L 43/0829; H04L 69/16; H04L 67/42

(57) ABSTRACT

A system includes a speed service architecture (SSA) capable of supporting high throughput connectivity between a server and client. The SSA may allow for a bandwidth measurement for a connection between the server and client. In some cases, the SSA may offload the processing of the connectivity measurement resulting in little or no load on processing devices external to the SSA, for example, the host processors of the client and/or server. The SSA may use a stream generator to generate a test stream for transmission over the connection. The test stream may be received and analyzed by a stream analyzer. The stream analyzer may then report the measurement results to the client, server, or other device.

### PRIORITY CLAIM

This application claims priority to U.S. Provisional application No. 62/182,675, filed 22 Jun.2015, and to U.S. Provisional application No. 62/051,356, filed 17 Sep.2014, which is entirely incorporated by reference.

### TECHNICAL FIELD

This disclosure relates to network analysis, and in particular to a high speed, low overhead determination of bandwidth between peer network devices.

### BACKGROUND

High speed data networks form part of the backbone of what has become indispensable worldwide data connectivity. Within the data networks, network devices such as switching devices direct data packets from source ports to destination ports, helping to eventually guide the data packets from a source to a destination. Improvements in identifying available bandwidth will further enhance the communication capabilities of data networks.

### BRIEF DESCRIPTION OF THE DRAWINGS

FIG. 1 shows an example of peers in communication with one another across networks.

FIG. 2 shows example device that may implement bandwidth determination between peers.

FIG. 3 shows one example implementation of a client/server architecture for bandwidth determination.

FIG. 4 shows another example implementation of a client/server architecture for bandwidth determination.

FIG. 5 shows a WAN upstream and downstream bandwidth test.

FIG. 6 shows a LAN upstream and downstream bandwidth test.

FIG. 7 shows a bandwidth test.

FIG. 8 shows a different bandwidth test.

FIG. 9 shows logic for bandwidth testing.

### DETAILED DESCRIPTION

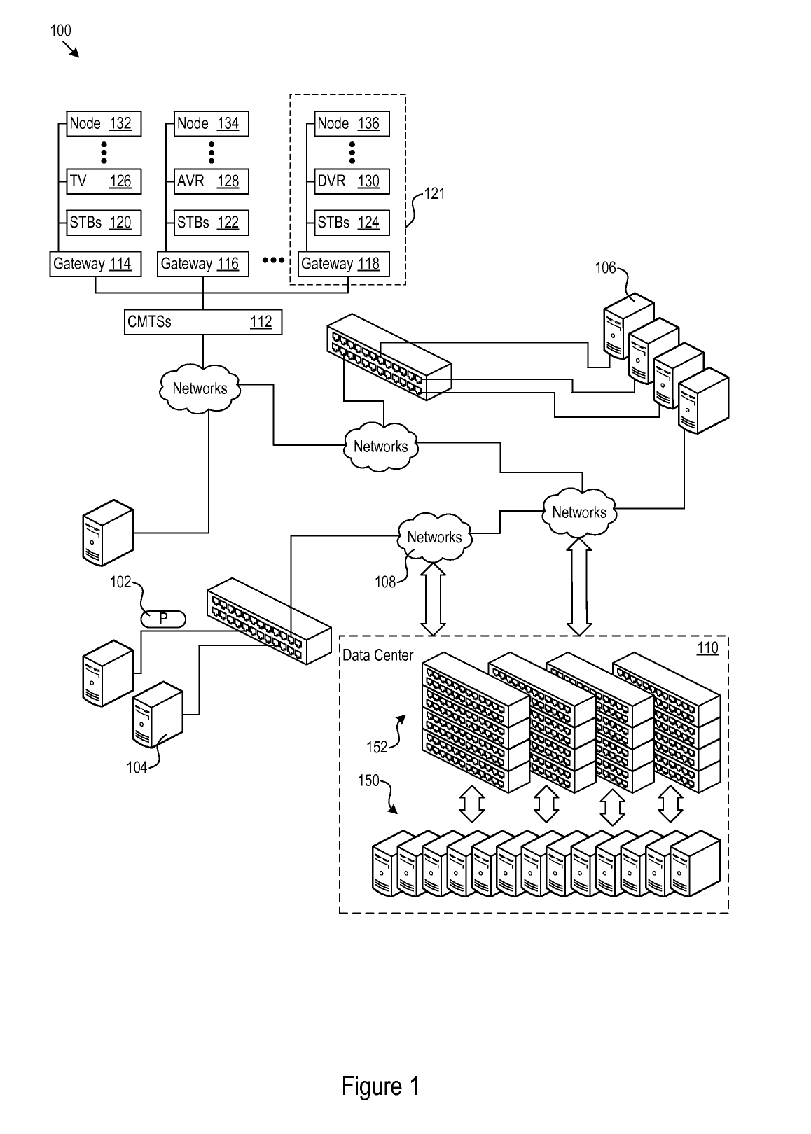

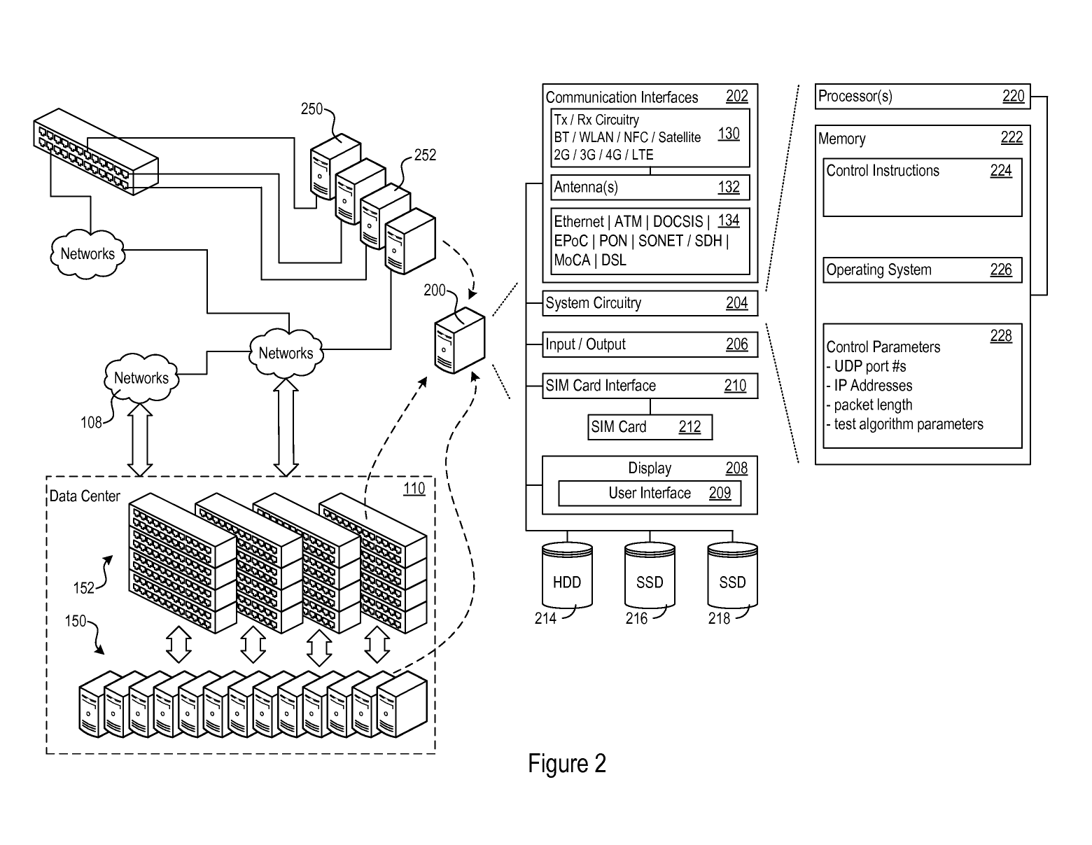

FIGS. 1 and 2 provide context for a discussion of the techniques for gigabit determination of available bandwidth between peers, discussed further below. The techniques may be implemented in a wide spectrum of devices communicating over a wide variety of networks for any given purpose.

FIG. 1 shows an example network 100. In the network 100, networking devices route packets (e.g., the packet 102) from sources (e.g., the source 104) to destinations (e.g., the destination 106) across any number and type of networks (e.g., the Ethernet/TCP/IP network 108). The networking devices may take many different forms and may be present in any number. The network 108 may span multiple routers and switches, for instance. Examples of network devices include switches, bridges, routers, and hubs; however other types of networking devices may also be present throughout the network 100.

The network 100 is not limited to any particular implementation or geographic scope. As just a few examples, the network 100 may represent a private company-wide intranet; a wide-area distribution network for cable or satellite television, Internet access, and audio and video streaming; or a global network (e.g., the Internet) of smaller interconnected networks. The data center 110 may represent a highly concentrated server installation 150 with attendant network switch and router connectivity 152. The data center 110 may support extremely high volume e-commerce, search engines, cloud storage and cloud services, streaming video or audio services, or any other types of functionality.

In the example in FIG. 1, the network 100 includes operators and providers of cable or satellite television services, telephony services, and Internet services. In that regard, for instance, FIG. 1 shows that the network 100 may include any number of cable modem termination system (CMTSs) 112. The CMTSs 112 may provide service to any number of gateways, e.g., the gateways 114, 116, 118. The gateways may represent cable modems, combined cable modems and wireless routers, or other types of entry point systems into any of a wide variety of locations 121, such as homes, offices, schools, and government buildings. The network 100 may include other types of termination systems and gateways. For example, the network 100 may include digital subscriber line (DSL) termination systems and DSL modems that function as the entry points into homes, offices, or other locations.

At any given location, the gateway may connect to any number and any type of node. In the example of FIG. 1, the nodes include set top boxes (STBs), e.g., the STBs 120, 122, 124. Other examples of nodes include network connected smart TVs 126, audio/video receivers 128, digital video recorders (DVRs) 130, streaming media players 132, gaming systems 134, computer systems 136, and physical media (e.g., BluRay) players. The nodes may represent any type of customer premises equipment (CPE).

It may be of particular importance or interest to determine the available bandwidth between any two peer devices communicating in the network 100. Further, it may be beneficial to do so in manner that directly tests the bandwidth for data transfer between the two devices. That is, the bandwidth tests preferably are free of influence by surrounding concerns, such as transmission control protocol (TCP) processing or hypertext transport protocol (HTTP) overhead and stack performance, and processor load or speed. The test architecture below achieves gigabit test rates, with little or no host CPU utilization. As a result, the CPU may remain dedicated to, e.g., running customer applications.

FIG. 2 shows example device 200 that may implement bandwidth determination between devices. In FIG. 2, the device 200 includes one or more communication interfaces 202, system circuitry 204, input/output interfaces 206, and a display 208 on which the device 200 generates a user interface 209. The communication interfaces 202 may include transmitters and receivers (“transceivers”) 238 and any antennas 240 used by the transceivers 238. The transceivers 238 may provide physical layer interfaces for any of a wide range of communication protocols 242, such as any type of Ethernet, data over cable service interface specification (DOCSIS), digital subscriber line (DSL), multimedia over coax alliance (MoCA), or other protocol. When the communication interfaces 202 support cellular connectivity, the device 200 may also include a subscriber identity module (SIM) card interface 210 and SIM card 212. The device 200 also includes storage devices, such as hard disk drives 214 (HDDs) and solid state disk drives 216, 218 (SDDs).

The user interface 209 and the input/output interfaces 206 may include a graphical user interface (GUI), touch sensitive display, voice or facial recognition inputs, buttons, switches, speakers and other user interface elements. Additional examples of the input/output interfaces 206 include microphones, video and still image cameras, headset and microphone input/output jacks, Universal Serial Bus (USB) connectors, memory card slots, and other types of inputs. The input/output interfaces 206 may further include magnetic or optical media interfaces (e.g., a CDROM or DVD drive), serial and parallel bus interfaces, and keyboard and mouse interfaces.

The system circuitry 204 may include any combination of hardware, software, firmware, or other logic. The system circuitry 204 may be implemented, for example, with one or more systems on a chip (SoC), application specific integrated circuits (ASIC), discrete analog and digital circuits, and other circuitry. The system circuitry 204 is part of the implementation of any desired functionality in the device 200. In that regard, the system circuitry 204 may include circuitry that facilitates, as just a few examples, connecting to a speed test control server, requesting a speed test, receiving in response the address of a data server, establishing a test connection with the data server, initiating bandwidth tests with the data server, and analyzing packet streams to determine test results.

The control server and data server may be any other devices in communication with the device 200, e.g., the control server 250 and the data server 252. There may be any number of control servers and data servers. Furthermore, a single device may implement the functionality of both a control server and a data server.

As just one example, the system circuitry 204 may include one or more processors 220 and memories 222. The memory 222 and storage devices 214, 216 store, for example, control instructions 224 and an operating system 226. The processor 220 executes the control instructions 224 and the operating system 226 to carry out any desired functionality for the device 200, including bandwidth determination functionality. The control parameters 228 provide and specify configuration and operating options for the control instructions 224, operating system 226, and other functionality of the device 200. As a few examples, the control parameters may include user datagram protocol (UDP) port numbers, internet protocol (IP) addresses, test algorithm parameters, such as packet lengths, number of iterations, latency thresholds, packet loss thresholds, and other parameters.

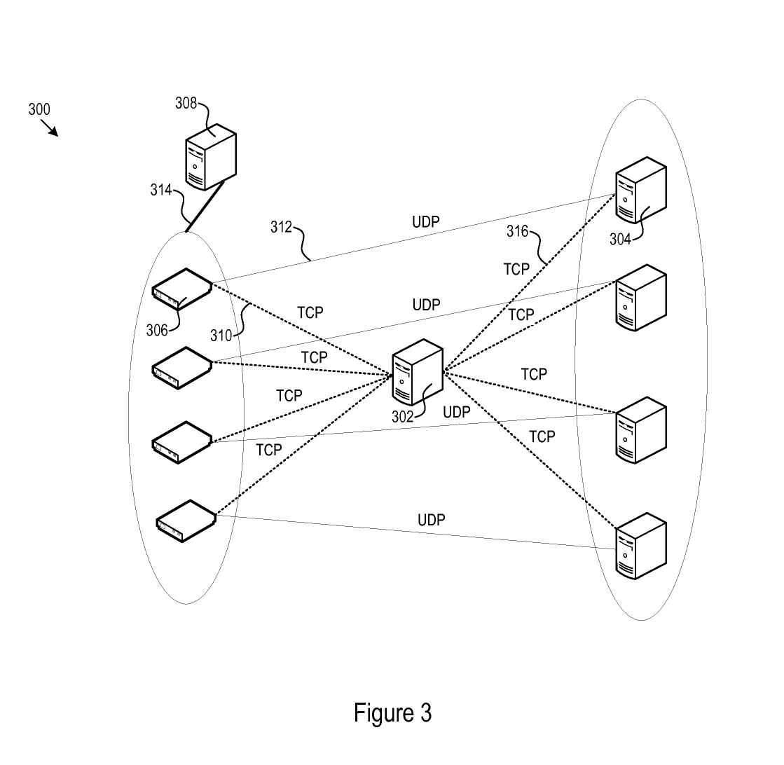

FIG. 3 shows one example implementation of a client/ server architecture 300 for bandwidth determination. The bandwidth determination may use a connectionless or stateless protocol in which each data unit, e.g., a packet, is individually addressed and routed based on information carried in each unit, rather than requiring explicit setup details to establish a prearranged, fixed data channel, as in connection-oriented communication. UDP is an example of a suitable connectionless protocol for the data traffic transfer. The architecture 300 thereby avoids the overhead of processing more complex connection-oriented protocols such as TCP and HTTP, which consume additional memory space and processing power than UDP. However, the architecture 300 may employ TCP or HTTP for control and management of the testing, as will be described below.

The server side of the architecture 300 includes, either logically or physically, a control server 302 and data servers, e.g., the data server 304. The control server 302 accepts connections from client devices, e.g., the client device 306 that will test bandwidth between the client device and a data server. As just two examples, the client device 306 may be a cable modem, DSL modem, or other type of gateway device.

The control server 302 coordinates the test process with the client devices. The control server 302 may also manage the data servers which are responsible for sending the data traffic, for a downstream bandwidth test, or receiving data traffic, for an upstream bandwidth test. The control server 302, client device 306, and data server 304 may implement a control protocol, a specific example of which is provided in detail below.

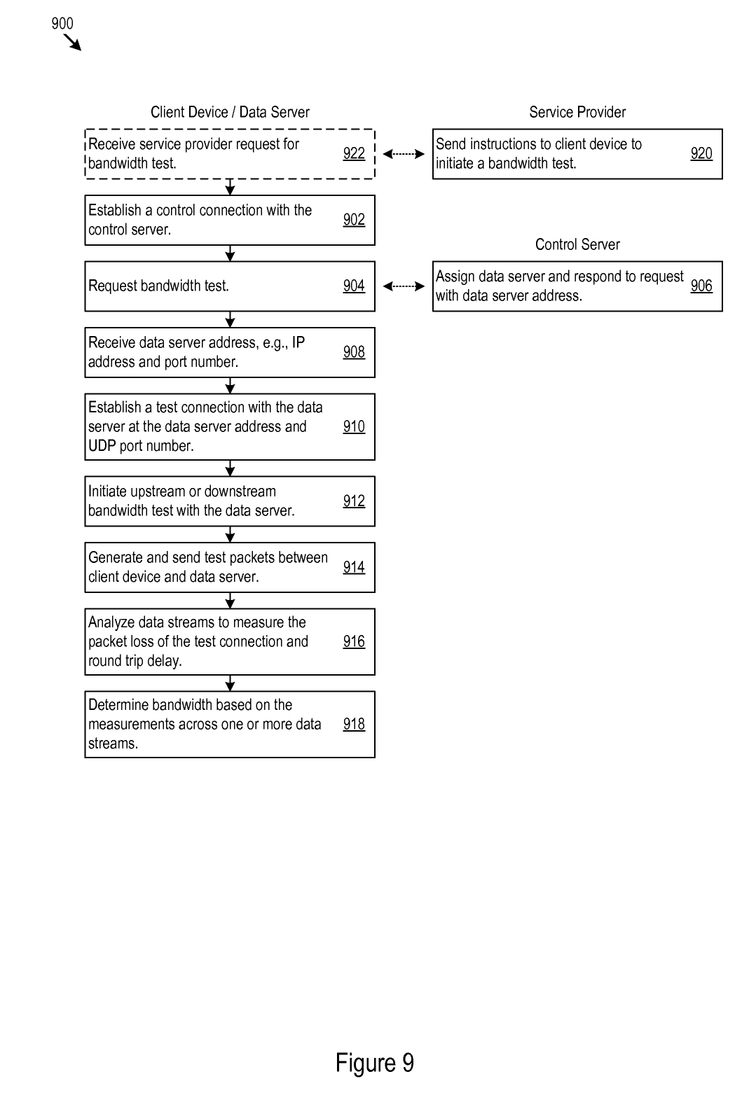

With reference also to the logic flow in FIG. 9, the system circuitry in the client device 306 may establish a control connection 310 with the control server 302 (e.g., over TCP) (902) and request a bandwidth test (904). Responsive to the request for the bandwidth test, the control server 302 assigns a data server to the client device (906), and the client device 306 receives a corresponding data server address and UDP port number from the control server 302 (908). The client device 306 establishes a test connection 312 with the data server 304 at the data server address and UDP port number (910), and initiates the bandwidth test between the client device 306 and the data server 304, e.g., over UDP (912). The bandwidth test may be an upstream bandwidth test or a downstream bandwidth test.

The bandwidth test includes generating and sending test packets in data streams between the client device and the data server (914). The data streams are analyzed to measure the packet loss of the test connection, and to measure round trip delay (916). A test algorithm determines bandwidth based on the measurements across one or more data streams (918).

In some implementations, there is no global clock, and instead the device generating the test traffic generates and inserts latency packets into the test traffic flow. The latency packets may be identified by a predetermined payload bit pattern inserted by the device generating the test traffic. The receiving device identifies the latency packet and returns it to the device generating the test traffic. Because the latency packet has the original time stamp from generation, the device generating the test traffic may determine the round trip delay.

Stated in another manner, the architecture 300 partitions the bandwidth test within the same traffic flow, e.g., the UDP test packet stream. In one aspect, the traffic flow includes the test packets that determine that bandwidth of the link. The receiving device may simply count and drop the test packets without any further substantial processing. In another aspect, the traffic flow includes special packets, e.g., the latency packet, on which to perform more specific processing, e.g., receive, recognize, and return to the sender.

FIG. 3 also shows a service provider 308. The service provider 308 may, for instance, send instructions 314 to the client device 306 to initiate a bandwidth test (920). The client device 306 receives the instructions and responds (922). The instructions 314 may include, e.g., a TCP/IP address and port number for the control server 302 to which the client device 306 should connect to request the bandwidth test.

Note also that the control server 302 may establish control connections to the data servers, e.g., the control connection 316. The control server 302 may use the control connection 316 to manage the data servers. For instance, the control connection 316 may convey diagnostic information to the control server 302 concerning which the load and number of ongoing bandwidth tests handled by the data server.

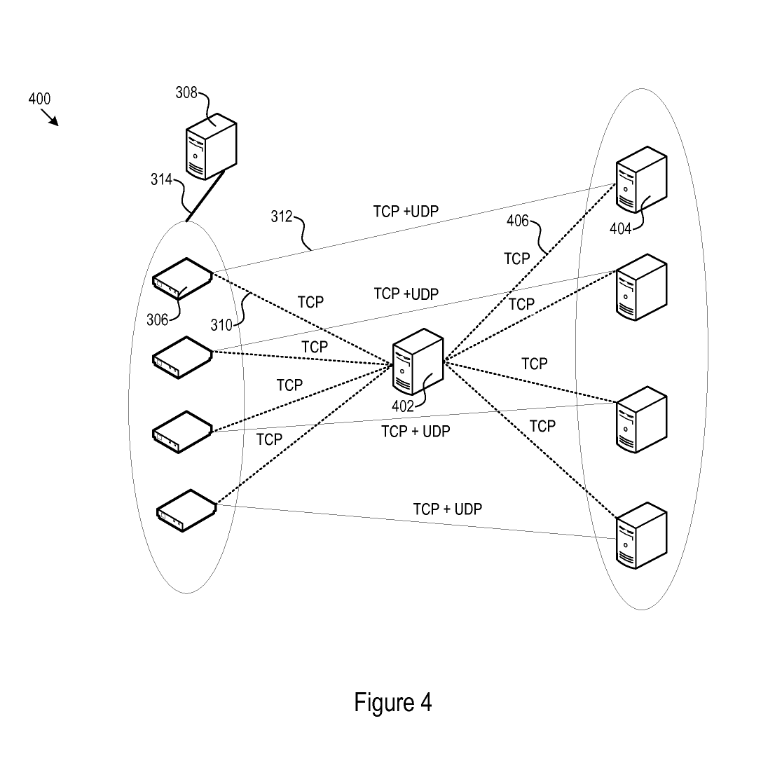

FIG. 4 shows another example implementation of a client/server architecture 400 for bandwidth determination. The architecture 400 includes a redirect server 402, and unified control and data servers, e.g., the unified server 404. The redirect server 402 may use status connections, e.g., the status connection 406, to determine and monitor which unified server is ready. The redirect server 402 redirects control server connections from the client device 306 to a particular IP address and port for a unified server. The client device 306 may then open both a TCP connection and a UDP connection to the assigned unified server. The TCP connection may carry the bandwidth test request and other communications between the client device 306 and the control server functionality of the unified server 404. The UDP connection may carry the test data traffic flow between the client device 306 and the control server functionality of the unified server 404.

In the architectures 300 and 400, the bandwidth test operates in connection with packet generator functionality and packet analyzer functionality. Either may be a hardware or software implementation. The packet generator functionality generates test packets that form the test traffic. The packets have a configured duration, payload length, and are sent at a specific test rate to test across a range of possible bandwidths. The packet analyzer functionality receives the test packets and updates statistics that reflect bandwidth and latency.

In some implementations, the packet generator and packet analyzer implement packet snooping to facilitate generation of test packets, and recognizing and receiving test packets. The packet generator and packet analyzer may use address information including a predetermined source IP address and port number, and destination IP address and port numbers.

The packet generator may be in the datapath, e.g., a network processor on an Ethernet interface in the communication interface 202. When the address information is established, the packet generator may listen on all interfaces for the different communication channels flowing through the communication interface. The packet generator may thereby recognize an initial packet addressed with the address information. After detecting the initial packet, the packet generator may determine packet characteristics (e.g., payload length) of the initial packet, and apply the packet characteristic as a template from which to generate a data flow of bandwidth test packets to the test partner. That is, the initial packet is a sample from which the packet generator generates the test packets in the bandwidth test traffic flow. Thus, the packet generator, e.g., at a network processor, may offload the task of generating test packets for bandwidth testing from packet circuitry that generated the initial packet.

The “packet circuitry” may generate the initial packet used as a template, and that the packet circuitry may be a host / system CPU, with the offload done from the host CPU to a network processor, e.g., on a network card to generate the test packet stream.

The packet analyzer may perform a similar analysis. That is, the packet analyzer may not know how the test packets will be received (e.g., the specific IP address), though it may have a preconfigured socket to which the packet analyzer is bound. Accordingly, the packet analyzer may watch all interfaces for the preconfigured socket to receive a matching packet. The packet analyzer may thereby determine the test packet characteristics. Note also that the packet analyzer may examine the packet payload to identify special packets, such as the latency packet. The packet analyzer may pass special packets up the stack for processing, but update statistics and drop test packets.

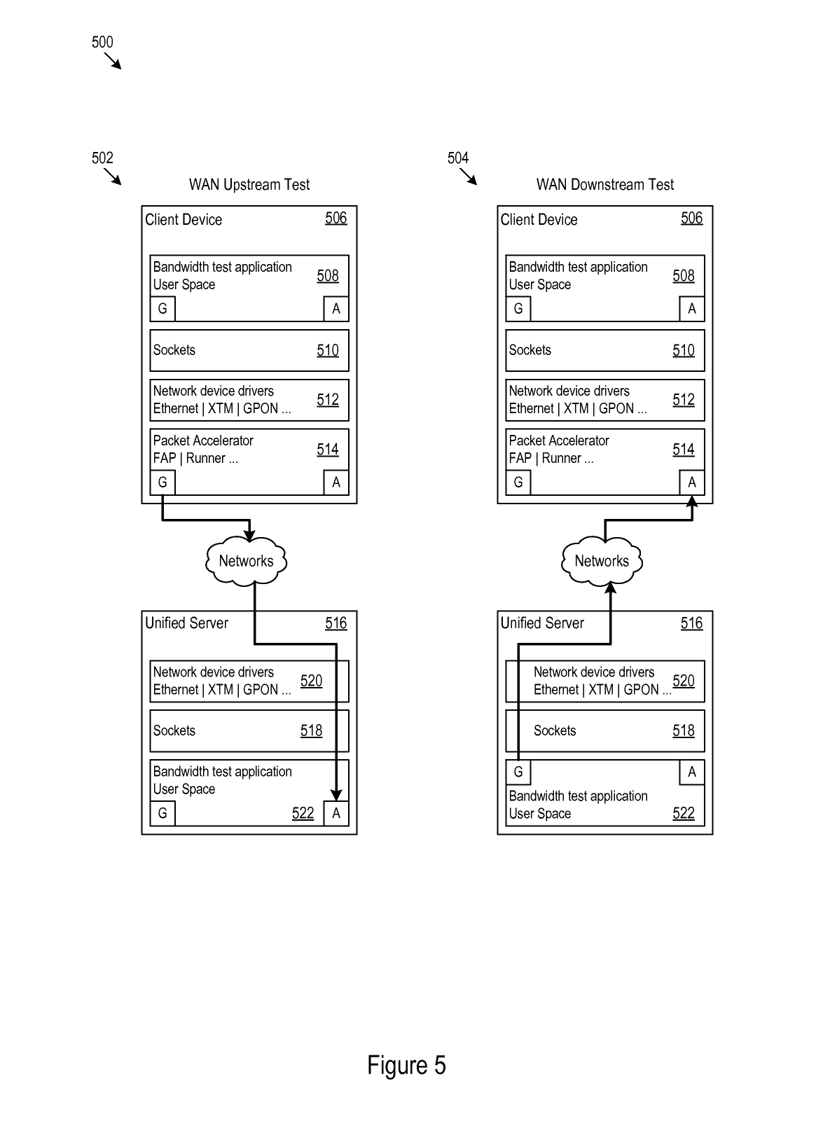

FIG. 5 shows network devices 500 configured to perform a wide area network (WAN) upstream bandwidth test 502 and downstream bandwidth test 504. The packet generator is denoted “G” and the packet analyzer is denoted “A”. In the upstream bandwidth test 502, the client device 506 (e.g., a CPE device) includes, in user space, a bandwidth test application 508, and the client device 506 is further configured with support for communication sockets 510 and network device drivers 512. In this example, the client device 506 includes a hardware packet accelerator 514.

The client device 506 communicates with a unified server 516 (e.g., a server computer system). The unified server 516 also includes support for communication sockets 518 and network device drivers 520. A bandwidth test application 522 also runs on the unified server 516.

For the upstream bandwidth test 502, the bandwidth test application 508 initiates the bandwidth test, including configuring the packet accelerator 614 with address and socket information bound to the bandwidth test process. The bandwidth test application 508 may send an initial packet that that packet accelerator 514 detects to use as a template, and generate the test packets in the bandwidth test traffic flow. The test packets traverse the network, and the unified server 516 receives them and passes them to the packet analyzer in bandwidth test application 522. The bandwidth test application 522 executes an available test algorithm on the test packets, determines results, and may send the results back to the client device 506.

For the WAN downstream test 504, the client device 506 requests the data server functionality in the unified server 516 to generate a bandwidth test traffic flow. In the unified server 516, the bandwidth test application 522 generates the test packets and sends them through the network to the client device. The packet analyzer in the packet accelerator 514 at the client device 506 receives the packets and executes an available test algorithm to determine bandwidth test results. The packet accelerator 514 communicates the bandwidth test results to the bandwidth test application 508. Note that the packet analyzer in the packet accelerator 514 may listen on the bound bandwidth test port across all interfaces to find the test packets.

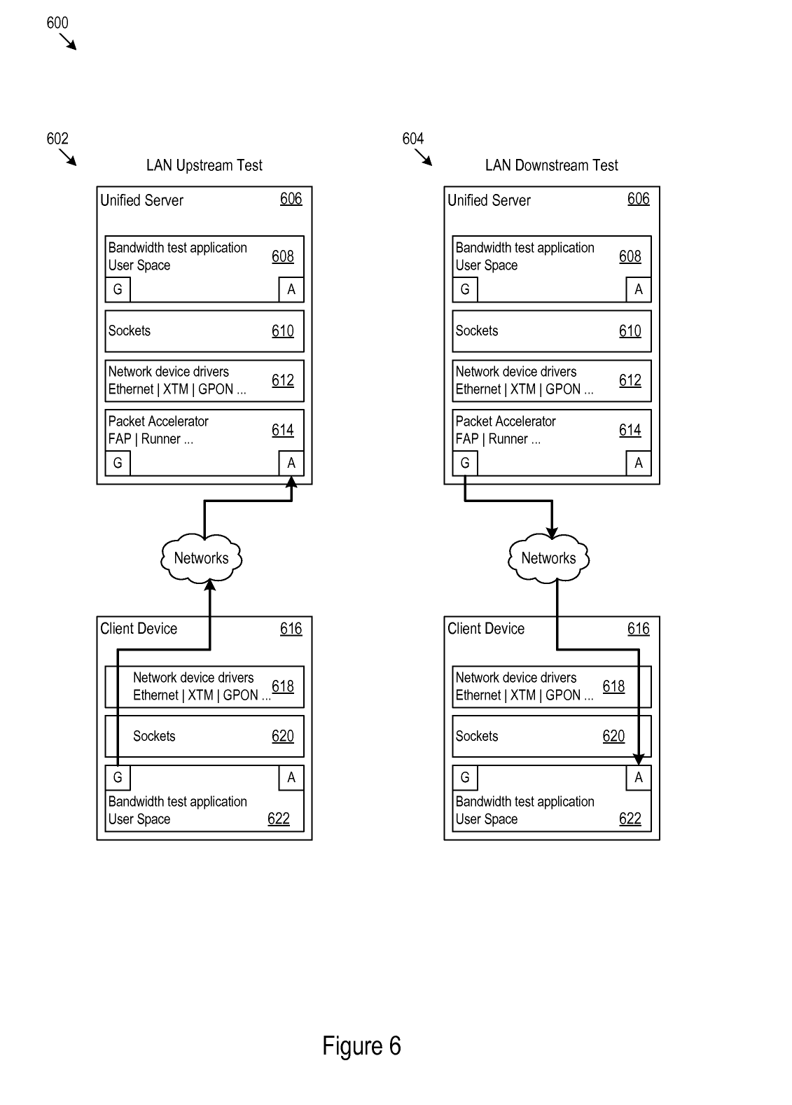

FIG. 6 shows network devices 600 configured to perform a local area network (LAN) upstream bandwidth test 602 and LAN downstream bandwidth test 604. The packet generator is denoted “G” and the packet analyzer is denoted “A”. In the upstream bandwidth test 602, the unified server 606 (e.g., a CPE device) includes, in user space, a bandwidth test application 608, and the unified server 606 is further configured with support for communication sockets 610 and network device drivers 612. In this example also, the unified server 606 includes a hardware packet accelerator 614.

The unified server 606 communicates with a client device 616 (e.g., a personal computer). The client device 616 also includes support for communication sockets 618 and network device drivers 620. A bandwidth test application 622 also runs on the client device 616.

In the upstream bandwidth test 602, the packet generator in the client device 616 generates the test packets. The test packets in the bandwidth test traffic flow reach the packet analyzer in the packet accelerator 614. The packet analyzer runs an available test algorithm on the received test packets and communicates test results back to the client device 616.

For the downstream bandwidth test 604, the packet accelerator 614 in the unified server 606 generates the test packets after having captured the characteristics of an initial packet sent by the bandwidth test application 608. The test packets form a bandwidth test traffic flow which reaches the packet analyzer implemented in the bandwidth test application 622. The packet analyzer runs an available test algorithm on the received test packets and determines the test results.

Test algorithms may be configured to perform a wide range of analyses. The test algorithm attempts to find the maximum bandwidth that passes one or more pre-configured bandwidth tests. As one specific example, the goal of the bandwidth test may be to find ‘Good Put’ (GP), where GP=Maximum Bandwidth@Packet Loss<Maximum Packet Loss. Expressed another way, GP is an estimate of the maximum bandwidth that can be achieved that has acceptable packet loss (which may be 0%). The test algorithm may perform a series of test steps until the GP is determined. In each test step, the test algorithm may analyze a given traffic flow of test packets. The result of the current test step may determine whether a new test step is executed, and another traffic flow generated for analysis. The test algorithm may report results to the client device, as examples, the GP in Kbps, the packet loss (e.g., a number or percentage of packets), and round trip delay (e.g., average round trip delay in psec).

All of the test algorithm parameters may dynamically set, e.g., as user-configurable parameters, fixed and pre-determined. In one implementation, the test algorithm is a binary search of an initial bandwidth range for a specific number of search steps. The binary search may begin with a specified maximum bandwidth, and end when: the specified maximum number of test steps is reached, or the traffic flow bandwidth equals the maximum bandwidth.

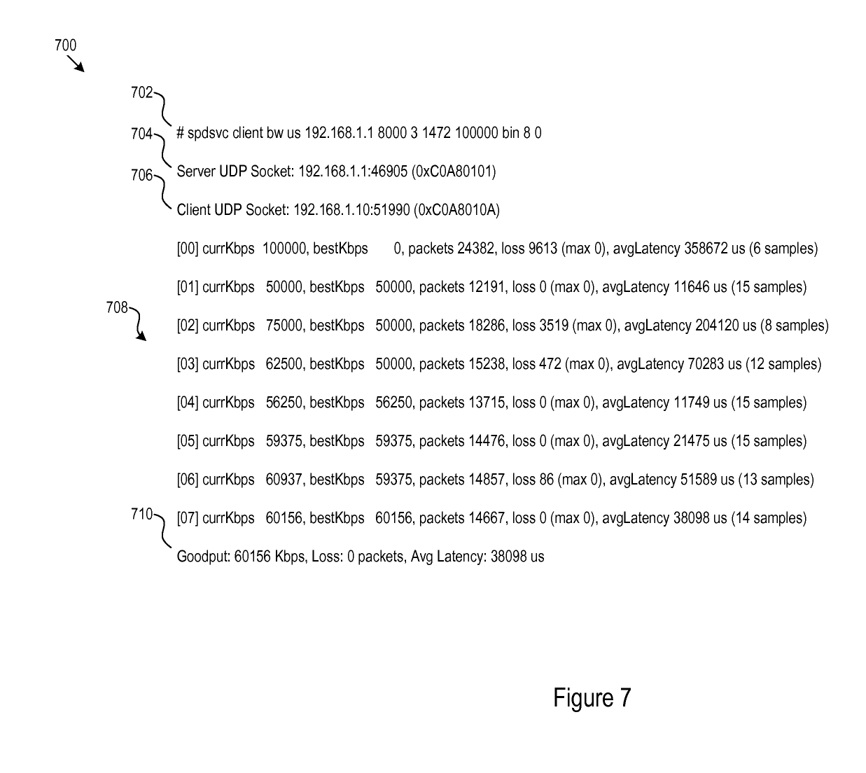

FIG. 7 shows a bandwidth test 700 using the binary search test algorithm over eight test steps. The client device initiates the test with the “spdsvc” command 702: spdsvc client bw us 192.168.1.1 8000 3 1472 100000 bin 8 0. This command accepts the following parameters: running the speed service application as a “client” running a bandwidth test algorithm “bw”, upstream, “us” test, with the address of the control server 192.168.1.1, port 8000. The command 702 further specifies running each test step for 3 seconds, with payload length 1472 bytes, where 100,000 is the specified expected maximum bandwidth (i.e., 100 Mbps), using the binary “bin” search algorithm for a maximum of 8 test steps. The command 702 sets the acceptable packet loss at zero percent.

In the example of FIG. 7, the assigned data server 704 is at IP address 192.168.1.1, port 46905, and the client application is at IP address 192.168.1.10, port 51900. The eight tests are labeled 708, and the binary search executes at test bandwidths: 100,000 Kbps (test 0, failed), 50,000 Kbps (test 1, passed), 75,000 Kbps (test2, failed), 62,500 Kbps (test 3, failed), 56,250 Kbps (test 4, passed), 59,375 Kbps (test 5, passed), 60,937 Kbps (test 6, failed), and finally 60,156 Kbps (test 7, passed). After eight test steps, the test output 710 is GP=60,156 Kbps.

Another example test algorithm uses the measured packet loss of the current test step to compute the next traffic flow bandwidth. For example, the test algorithm may implement:

If current Test Step packet loss>=15%

Next Test Stream Bandwidth=Current Test Stream Bandwidth*85%

The test ends when, for instance:

Maximum Number of Steps is reached, OR

Test Stream Bandwidth equals Maximum Bandwidth

This test algorithm often converges faster than a binary search, e.g., in two test steps.

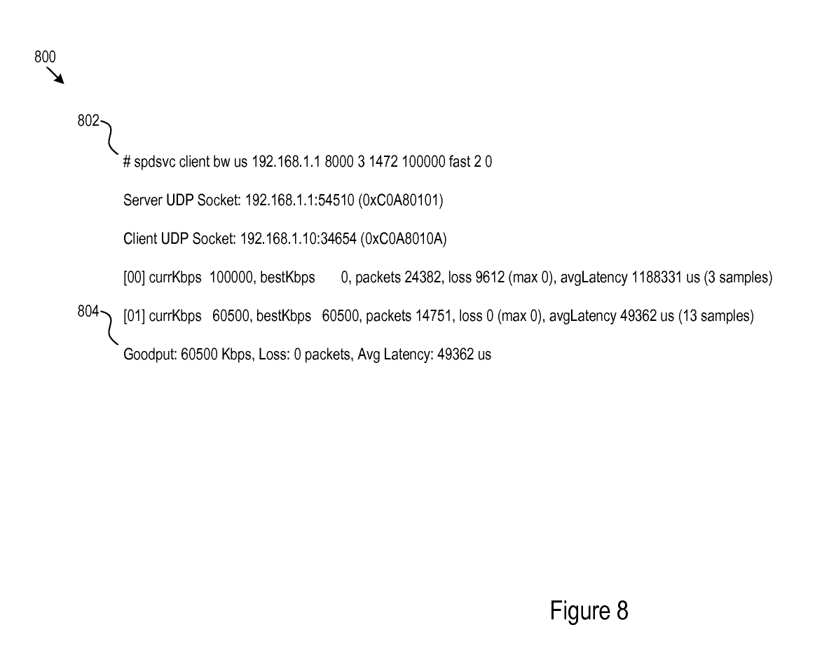

FIG. 8 shows an example of a bandwidth test 800 using this test algorithm. The test command 802 specifies the “fast” algorithm for two test steps, rather than “binary” for eight test steps. After two test steps, the test output 804 is GP=60,500 Kbps.

The test algorithm may also address network buffering, which can skew bandwidth measurements because it artificially reduces packet loss. As one example, the bandwidth algorithm may run each test step for a longer time to reduce buffering interference, e.g., three or more seconds per test step. As another example, the algorithm may use both packet loss and round-trip delay to qualify successful/failed test steps. In some implementations, the typical round-trip latency is obtained prior to generation of the test streams. Then, at each test step the test algorithm compares the obtained round-trip latency against the typical latency. If the obtained latency is significantly higher (above a predetermined threshold) than the typical latency, the test step is voided and a new test step is issued.

For instance, the test algorithm may implement a hybrid binary search:

Good Put=Maximum Bandwidth@Packet Loss<Maximum Packet Loss AND Round-Trip Delay<Minimum Round-Trip Delay+Margin (%).

The hybrid binary search implements a round trip delay filter to further determine when a particular test step has passed or failed. Adding the round trip delay filter may allow each test step to run for a shorter duration, e.g., 1 second.

The test algorithm may also be run at various intervals, e.g., periodically, pseudo-randomly, or other interval, to detect increasing or decreasing delay or packet loss after a first successful test is run and a maximum bandwidth value is selected.

Additionally or alternatively, a comparison between multiple test steps may be used (e.g., a search). For example, the round-trip latency may be tracked along with packet loss. In some cases, as the test step bandwidth is reduced packet loss may hold steady, but round-trip latency may continue to decrease as the bandwidth is decreased between test steps. Similarly, round-trip latency may increase as the bandwidth between test steps increases. Once test step bandwidth reaches a value that results in little or no network buffering, the round-trip delay and packet loss may not necessarily change as the bandwidth between test steps is changed, e.g., a bandwidth level for which the derivative of the round-trip AND the packet loss with respect to test-step bandwidth is zero (or below a predetermined threshold). Thus, in some implementations, the test algorithm may search for the maximum bandwidth value for which there is a pre-determined differential relationship to the packet loss or round-trip delay level, e.g., instead of a particular absolute packet loss or absolute round-trip delay level.

As another example implementation of a system that performs bandwidth testing, the system may include a communication interface configured to communicate with a speed test control server and communicate with a data server. The system includes test control circuitry configured to establish a transmission control protocol (TCP) control connection with the speed test control server, request a speed test from the speed test control server, and responsive to the request for the speed test, receive a data server address from the speed test control server.

The system also establishes a user datagram protocol (UDP) test connection with the data server at the data server address and initiates a bandwidth test between the system and the data server. In the system, analysis circuitry is configured to receive a test data stream from the data server, separate out from the test data stream latency packets and non-latency packets, and determine a round trip latency from the data server to the system with the latency packets. The analysis circuitry may also determine a packet loss with the non-latency packets and determine whether the test data stream provides a maximum bandwidth estimate in view of the round trip latency and the packet loss. In that regard, the analysis circuitry is configured to compare the packet loss against a pre-determined packet loss threshold and compare the round trip latency against a pre-determined latency threshold.

In some implementations, the client device implements multiple modes of operation. For example, the client may have two modes of operation:

First Mode: Send: In the example send mode, a test stream (e.g., a single test stream) with specified parameters may be transmitted and the obtained results are reported. This mode may allow an operator to spot check an interface's bandwidth, or to implement a custom GP search algorithm.

Second Mode: Bandwidth: the client device and data server autonomously exchange one or more test streams based on the specified parameters. The exchange continues until either GP is determined, or the maximum number of test steps is reached. The obtained results are then reported.

Examples of client device parameters include:

| Parameter | Explanation |
|---|---|
| <upstream/downstream> | Direction |
| Upstream (us) | Client to server |
| Downstream (ds) | Server to client |
| <server_ip> | Server IP Address |
| <tcp_port> | Server TCP port |
| <duration_sec> | Duration of test stream |
| <packet_length> | The UDP payload length of packet in a test |
| | stream. Multiple packets in a test stream may |
| | have the same length. |
| <kbps> | The test stream bandwidth (Send mode) |
| <max_kbps> | The maximum expected bandwidth of the |
| | interface under test (Bandwidth mode) |
| <fast/bin> | GP search algorithm |
| <max_steps> | The maximum number of test steps allowed |
| <loss_percentage> | The maximum allowed loss on a test stream. |
| | When a test stream packet loss is smaller than |
| | or equal to <loss_percentage>, it will be |
| | considered lossless by the goodput search |
| | algorithm. A zero value may indicate that that |
| | no packet loss may be tolerated for a goodput |
| | computation. |

The control server application parameters may vary widely depending on the implementation, and as one example may include:

| Parameter | Explanation |
|---|---|
| <tcp_port> | Server TCP port |
| <udp_port> | The UDP port number used for the test stream UDP |
| | connection. When zero is specified, a random port |
| | number may be used. |
| <lock_file> | An optional file is created at the beginning of a client |
| | session, then removed when the client session ends. |
| | This file can be used in the server to determine |
| | whether any sessions are currently in progress. |

The architectures described above may support streamlined implementation of the packet generator and packet analyzer in any of a wide variety of communication systems such as those supported by Broadcom devices BCM63138, BCM63168, BCM6838, and/or other devices. The architectures may provide gigabit speeds for testing purposes with little or no load on the host CPU by offloading bandwidth testing to hardware accelerators.

In the architectures described above, the underlying network stack, such as a software stack or hardware stack, may be responsible for building and transmitting packets to networking interfaces using the payloads sent to the socket by the test application. The network stack may also map packets received at networking interfaces to the sockets used by the architectures for reception.

A UDP socket may be defined by the following tuple: source IP address, destination IP address, UDP source port, and UDP destination port. However, UDP sockets many not necessarily provide information about other network layers such as Ethernet, virtual local area network (VLAN), point-to-point protocol over Ethernet (PPPoE), IP tunnels, or other network layers. In some cases, the architectures may use information from other network layers to identify test packets. The architectures may abstract this information from the socket into the underlying network stack.

In some cases, packet generators and packet analyzers are not necessarily integrated with the software network stack. To address this lack of integration, the full packet contents may be explicitly configured in order to allow generation of test stream packets and classification of received traffic into test stream packets. However, this is information may not necessarily be available to the client device and the data server due to the socket nature of their connections.

To make this information available the architectures may define an application programming interface (API) for the hardware running the packet generator and packet analyzer. The architecture may use this API to configure the UDP socket tuple obtained once the UDP connection is established. The tuple is used by the hardware running the stream generator to detect test packet headers for stream packets transmitted by the test application to network interfaces. The tuple is used by the hardware running the packet analyzer to capture test stream packets received from the network interfaces.

In hardware-based packet generator implementations, the client device or bandwidth test application may setup the tuple for the packet generator and enable the packet generator. The packet generator may examine packets transmitted by the networking stack to search for the tuple. The client device or bandwidth test application may transmit a test stream packet to the socket, with the packet containing the packet generator configuration parameters in the packet payload.

The packet generator detects the test stream packet and intercepts it. The packet generator may extract the configuration parameters from the packet payload and apply them as a template for test packets. The intercepted packet may also include the packet headers applied through the stack for packet generation. Accordingly, the packet generator may use the intercepted packet, including packet headers, as the template for generating the test packets in the traffic flow to the same network interface and queue that were the destination of the intercepted packet.

In hardware-based packet analyzer implementations, the client device or bandwidth test application may setup the Tuple for the packet analyzer and activate the packet analyzer. The packet analyzer may examine packets received from the network interfaces. The packet analyzer may drop detected test packets and responsively update test statistics. Once the traffic flow finishes, the client device or bandwidth test application obtains the packet analyzer statistics through an API.

In the example binary search algorithm, the test stream bandwidth at individual steps step is adjusted following a binary search progression. An example binary search algorithm pseudo code implementation is shown below:

```
Initialization
    current_bandwidth = user-specified maximum bandwidth;
    minimum_bandwidth = 0;
    maximum_bandwidth = current_bandwidth;
    step_count = 0;
    maximum_steps = user-specified maximum number of steps
    (> zero);
    goodput = 0;
    goodput_latency = 0;
While  (step_count  <  maximum_steps)  AND
(minimum_bandwidth  != maximum_bandwidth)
    Send test stream at current_bandwidth;
    If (packet_loss == 0) AND (current_bandwidth > goodput)
        goodput = current_bandwidth;
        goodput_latency = round-trip latency of current test stream;
    Endif
    If (packet_loss > 0)
        maximum_bandwidth = current_bandwidth;
    else
        minimum_bandwidth = current_bandwidth;
    end if
    current_bandwidth = (maximum_bandwidth +
    minimum_bandwidth) / 2;
End While
Report the goodput and goodput_latency
```

In some implementations, SSA tests may run in a service-provider managed network. In some cases, service-provider test may be subject to network level quality of service (QoS). To avoid managed services disruption, SSA test streams may be prioritized at a higher level than “best effort” traffic such as internet browsing, and at a lower level than traffic related to services that managed by the service-provider, such as IPTV or VoIP. In this case, the bandwidth measurements will indicate the bandwidth available for unmanaged services. Additionally or alternatively, tests may be performed at a priority higher than any other services and the calculated connection data may reflect the capabilities of the entire system.

In some cases, managed services may be disabled in the system under test. In such cases, QoS enforcement may not necessarily affect the SSA bandwidth measurements. For example, if no managed services are active at the time of measurement, the SSA measurement may report the total bandwidth available.

An example protocol specification is provided below. However, other protocol implementations may be used.

Example Protocol: Session Initiation

The client device SHALL establish a TCP control connection to a control server on
an address/port chosen for the control server. The control server SHOULD listen
for and accept a large number of connections concurrently. The control server or
client device MAY abort or abandon any session by simply dropping the TCP
control connection. In the control channel, all messages SHALL be followed by a
NEWLINE. Messages MAY have additional whitespace added between or after
parameters.
The control server SHALL respond to the connection by sending the string “Speed
Service 1.0” followed by a newline.
The client device SHALL request assignment of a data stream resource by sending
the string “DATA 1.0” followed by a newline. In the future, if the control server
offers a higher protocol version number and the client device sends “DATA 1.0”,
we expect a control server will continue to support the 1.0 protocol.
At any point prior to issuing the DATA_ACK, the control server MAY respond with
“REDIRECT ip_address port”. In response, the client device MUST terminate the
control connection. The client device then SHOULD connect to the specified
ip_address and port and begin the control protocol anew. A client device that is
redirected more than 10 times MAY consider the control server network to be
broken.
While a control server may act as its own data stream resource, the protocol is
designed so that the control server can manage a pool of data stream resources
and assign them to waiting client devices as they become available. Such a
control server presumably would open its own, implementation-specific connection
to another machine and ask it to spawn a data stream process, allocate a set of
UDP ports, and report the port number back to the control server.
The control server SHALL respond to “DATA” with DATA_ACK ip_address port. If
the control connection is made to an IPv4 address, the ip_address is a numeric
address expressed as a dotted quad. The control server MAY delay this response
until it has a data stream resource ready to assign.

Example Protocol: Data Session

To establish the data session, the client device SHALL send a UDP datagram to
the specified address and port with the UDP payload “SPEED” followed by a
newline. The control server SHALL respond with a UDP datagram containing
“SPEED_ACK” followed by a sessionid and a newline. The client device MAY
repeat this periodically if no SPEED_ACK is received.
To run a test burst, the client device SHALL send “PREPARE” followed by the
whitespace-separated integers sessionid, mode, packets, length, kbps, msec.
Sessionid: an integer (U32) used to associate the control session with the
data packets
Mode:
TEST_MODE_SEND_US = 0,
TEST_MODE_SEND_DS = 1,
TEST_MODE_BW_US = 2
TEST_MODE_BW_DS = 3
TEST_MODE_MAX = 4,
Length: length of each packet payload EXCLUDING layer 1-3 headers
Kbps: rate in kbps of layer 3 payload data not including headers
MSec: number of milliseconds to send
The control server SHALL respond with “PREPARE_ACK” followed by a newline.
The client device SHALL send “START” followed by the sessionid and a newline.
The control server SHALL send “START_ACK” followed by a newline

Example Protocol: Upstream Mode

The client device sends data stream UDP datagrams at the rate it specified. Each
datagram MUST contain the payload “STREAMabcdefghi” followed by a null
character. After these first 16 bytes, the client device MAY fill the packet with any
value it chooses.
During the transfer, the client device SHOULD occasionally send a latency
measuring datagram. These datagrams contain the payload “LATENCY” followed
by a space followed by up to 16 decimal digits followed by null character. The
decimal number is ordinarily expected to be a timestamp according to the client
device's clock and in units appropriate to the client device. After the initial null, the
remainder of the packet SHOULD be padded to the same length as the data
stream datagrams.
Immediately upon receipt of a LATENCY packet, the control server MUST respond
with a datagram containing “LATENCY_ACK” followed by a space followed by the
same string of digits found in the incoming LATENCY packet followed by a null
character and a “running” flag. The running flag will be “1” if the control server is
currently generating packets towards the client device and “0” if the control server
is not currently generating packets towards the client device. During the test, the
client device SHOULD use the LATENCY_ACK packets to record the latency at
various points. It SHOULD also use a heuristic to determine if data is being
buffered in the system, indicative of exceeding network bandwidth even if no
packet are lost during a short test. If the latency is found to be growing during a
test, the client device MAY abort the data stream and treat the result as equivalent
to one with packet loss.
The control server MUST count the total number of packets received. The control
server MAY filter the packets to identify the STREAM and LATENCY packets
specifically.
At the conclusion of a test, the client device MUST notify the control server via the
TCP control channel by sending “READY” followed by a space and the session id
followed by a newline.
The control server MUST respond in the TCP control channel with “READY_ACK”
followed by a space, the sessionid, space, the number of packets received, a
space, and the size in bytes of the L2/L3 packet headers if known. If not known
the size should be reported as zero.

Example Protocol: Downstream Mode

The client device sends data stream UDP datagrams at the rate it specified. Each
datagram MUST contain the payload “STREAMabcdefghi” followed by a null
character. After these first 16 bytes, the control server MAY fill the packet with any
value it chooses.
During the transfer, the client device SHOULD occasionally send a latency
measuring datagram. These datagrams contain the payload “LATENCY” followed
by a space followed by up to 16 decimal digits followed by null character. The
decimal number is ordinarily expected to be a timestamp according to the client
device's clock and in units appropriate to the client device. After the initial null, the
remainder of the packet SHOULD be padded to the same length as the data
stream datagrams.
Immediately upon receipt of a LATENCY packet, the control server MUST respond
with a datagram containing “LATENCY_ACK” followed by a space followed by the
same string of digits found in the incoming LATENCY packet followed by a null
character and a “running” flag. The running flag will be “1” if the control server is
currently generating packets towards the client device and “0” if the control server
is not currently generating packets towards the client device. During the test, the
client device SHOULD use the LATENCY_ACK packets to record the latency at
various points. It SHOULD also use a heuristic to determine if data is being
buffered in the system, indicative of exceeding network bandwidth even if no
packet are lost during a short test. If the latency is found to be growing during a
test, the client device MAY request an abort of the data stream by sending a
datagram containing “STOP” followed by a NULL. The control server MAY react to
STOP by immediately terminating the downstream burst.
The client device MUST count the total number of packets received. The client
device MAY filter the packets to identify the STREAM and LATENCY packets
specifically.
At the conclusion of a test, the client device MUST notify the control server via the
TCP control channel by sending “READY” followed by a space and the session id
followed by a newline.
The control server MUST respond in the TCP control channel with “READY_ACK”
followed by a space, the sessionid, space, the number of packets received (zero),
a space, and the header size (0)

Example Protocol: Test Sequencing

After a READY_ACK, the client device MAY return to the PREPARE operation to
start another burst.
When the test is complete, the client device MUST send the control server “END”
followed by space, the session id, space, then zero or more tuples as described
below, followed by a newline
“DS_PL_bandwidth = number” with the downstream payload bandwidth in kbps
“DS_FULL_bandwidth = number” with the downstream bandwidth including headers
in kbps (if known)
“DS_latency = number” with the downstream latency in microseconds (if known)
“US_PL_bandwidth = number” with the upstream payload bandwidth in kbps
“US_FULL_bandwidth = number” with the upstream bandwidth including headers in
kbps (if known)
“US_latency = number” with the upstream latency in microseconds (if known)

Example Protocol: Session Timeout

If the client device exceeds time limits set by the control server or fails to
initiate a new control command for 10 seconds, the control server MAY
drop the control connection.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only

Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A system comprising:
a communication interface configured to:
communicate with a test control server; and
communicate with a data server; and
control circuitry configured to:
establish a control connection with the test control server and request a bandwidth test; and
responsive to the request for the bandwidth test, receive a data server address from the test control server;
establish a test connection with the data server at the data server address; and
initiate the bandwidth test between the system and the data server.

2. The system of claim 1, where:
the control circuitry is configured to execute the bandwidth test from among multiple different bandwidth tests available to the system, according to a bandwidth test selection parameter.

3. The system of claim 1, where:
the bandwidth test comprises a downstream test from the data server to the system.

4. The system of claim 3, further comprising:
analysis circuitry configured to:
receive data streams from the data server; and
execute a search strategy on the data streams to find a maximum bandwidth estimate for downstream traffic.

5. The system of claim 4, where the search strategy includes:
determining packet loss and comparing the packet loss to a packet loss threshold.

6. The system of claim 5, where the search strategy further includes:
determining round trip delay from the data server to the system, and comparing the round trip delay to a delay threshold.

7. The system of claim 4, where the search strategy includes:
a binary search of an initial bandwidth range for a specific number of search steps.

8. The system of claim 1, where:
the bandwidth test comprises an upstream test from the system to the data server.

9. The system of claim 1, where:
the bandwidth test comprises:
setting a packet loss threshold;
measuring packet loss in a given data stream among the data streams; and
when packet loss exceeds the packet loss threshold, adjusting bandwidth downward for a subsequent data stream after the given data stream by a predetermined reduction ratio.

10. The system of claim 9, where:
the bandwidth test further comprises executing for no more than a pre-determined number of iterations.

11. The system of claim 1, where:
the control connection comprises a connection based, error-checked delivery connection.

12. The system of claim 11, where the control connection comprises a transmission control protocol (TCP) connection.

13. The system of claim 1, where:
the test connection comprises a connectionless delivery connection.

14. The system of claim 13, where the test connection comprises a user datagram protocol (UDP) connection.

15. A system comprising:
a communication interface; and
controller circuitry in communication with the communication interface, the controller circuitry configured to:
obtain a test partner address for a bandwidth test; and
monitor across multiple different communication channels flowing through the communication interface to detect an initial packet directed to the test partner address;
after detecting the initial packet:
determine a packet characteristic of the initial packet; and
apply the packet characteristic as a template from which to form test packets for a bandwidth test packet stream to the test partner.

16. The system of claim 15, where the controller circuitry is further configured to, after detecting the initial packet:
generate the bandwidth test packet stream to the test partner as a sequence of test packets adhering to the template; and
transmit the test packets to the test partner.

17. The system of claim 16, where the controller circuitry is configured to offload generation of the test packet stream from packet circuitry that generated the initial packet, by generating, instead of the packet circuitry, the bandwidth test packet stream to the test partner as a sequence of test packets adhering to the template.

18. The system of claim 15, where the packet characteristic comprises:
a port number, a network address, a payload length, or any combination thereof.

19. A system comprising:
a communication interface configured to:
communicate with a speed test control server; and
communicate with a data server; and
control circuitry configured to:
establish a transmission control protocol (TCP) control connection with the speed test control server;
request a speed test from the speed test control server; and
responsive to the request for the speed test, receive a data server address from the speed test control server;
establish a user datagram protocol (UDP) test connection with the data server at the data server address; and
initiate a bandwidth test between the system and the data server; and
analysis circuitry configured to:
receive a test data stream from the data server;
separate out from the test data stream latency packets and non-latency packets;
determine a round trip latency from the data server to the system with the latency packets;
determine a packet loss with the non-latency packets; and
determine whether the test data stream provides a maximum bandwidth estimate in view of the round trip latency and the packet loss.

20. The system of claim 19, where the analysis circuitry is configured to:
compare the packet loss against a pre-determined packet loss threshold; and
compare the round trip latency against a pre-determined latency threshold.
